(19) United States
(12) Patent Application Publication
(10) Pub. No.: US 2025/0015749 A1
(43) Pub. Date: Jan. 9, 2025

(54) METHOD FOR DETERMINING AN ARRANGEMENT OF PHOTOVOLTAIC PANELS ON AREAS OF A TERRITORY

(71) Applicant: TotalEnergies One Tech, COURBEVOIE (FR)

(72) Inventors: Gilles POULAIN, ANTONY (FR); Emmanuel LE BORGNE, CHATILLON (FR); Duv Hguyen DUONG, PARIS (FR)

(73) Assignee: TotalEnergies One Tech, COURBEVOIE (FR)

(21) Appl. No.: 18/697,975

(22) PCT Filed: Oct. 5, 2022
(86) PCT No.: PCT/EP2022/077687

§ 371 Date: Apr. 2, 2024

(30) Foreign Application Priority Data
Oct. 6, 2021 (FR) 2110585

(51) Int. Cl. H02S 20/32; G06Q 10/04; G06T 7/73

(52) U.S. Cl. CPC H02S 20/32; G06Q 10/04; G06T 7/75; G06T 2207/10032; G06T 2207/30184

(57) ABSTRACT

The present invention relates to a method for determining an arrangement (A) of photovoltaic panels on zones of a territory, called target zones (Z_{C}), the method comprising the reception a bird's eye image of the territory, detecting each target zone (Z_{C}) on the image so as to obtain a zone mask, applying the zone mask on the image so as to obtain a target image, detecting the contours on the target image so as to obtain a contour mask, combining the zone mask and of the contour mask so as to obtain an obstacle mask, and determining the arrangement (A) of photovoltaic panels on each target zone (Z_{C}) of the image depending on the obstacle mask so that each photovoltaic panel covers a segment of a target zone (Z_{C}) free of obstacles (O).

### CROSS REFERENCE TO RELATED APPLICATION

The present application is a U.S. National Phase Application under 35 U.S.C. § 371 of International Patent Application No. PCT/EP2022/077687 filed Oct. 5, 2022, which claims priority of French Patent Application No. 21 10585 filed Oct. 6, 2021. The entire contents of which are hereby incorporated by reference.

### FIELD OF THE INVENTION

The present invention relates to a method for determining an arrangement of photovoltaic panels in zones of a territory. The invention further relates to an associated computer program method with such method.

### BACKGROUND

The production of electricity from renewable energies is a challenge for our societies. To this end, dedicated installations have been developed, including photovoltaic panels which are used for producing electricity from solar energy. Photovoltaic panels are conventionally installed on the roofs of buildings, for maximizing the energy recovered at the consumption site.

To optimize the deployment of photovoltaic panels, tools have been developed for estimating the solar production of a future installation, and thereby evaluating the profitability thereof.

Nevertheless, the estimates made are generally based on a rough distribution of photovoltaic panels over the surfaces of interest. However, some surfaces are actually incompatible with the installation of photovoltaic panels, which distorts the estimates.

There is thus a need for a tool giving a more precise determination of the possibilities of installing photovoltaic panels in zones of a territory.

### SUMMARY

To this end, the subject matter of the present description is a method for determining an arrangement of photovoltaic panels on zones of a territory, called target zones, the method being implemented by computer and comprising the following steps:
a. the reception of a bird's eye view image of a territory comprising at least one target zone,
b. the detection of each target zone on the image by means of the segmentation of the image so as to obtain a mask of the target zones of the image, called zone mask,
c. the application of the zone mask over the image so as to obtain an image, called target image, on which only the target zone(s) of the image are represented,
d. the detection of contours on the target image so as to obtain a contour mask, the detected contours representing obstacles on the target zone(s),
e. the highlighting of obstacles on each target zone of the image by combining the zone mask and the contour mask so as to obtain a mask of the obstacles present on the target zone(s) of the image, called obstacle mask, and
f. the determination of an arrangement of photovoltaic panels on each target zone of the image based on the obstacle mask so as to satisfy at least one positioning requirement, the at least one positioning requirement stipulating that each photovoltaic panel covers a segment of a target zone free of obstacles.

According to other particular embodiments, the method comprises one or more of the following features, taken individually or according to all technically possible combinations:
the method comprises, at the end of the determination step, obtaining a resulting image corresponding to the image of the territory with superimposed on the target zone(s) of the image, the determined arrangement of photovoltaic panels;
the determination step comprises the positioning of representative shapes of photovoltaic panels on the surface of each target zone of the obstacle mask, followed by the removal of shapes at least partially superimposed on an obstacle, the determined arrangement of photovoltaic panels corresponding to the remaining shapes;
the positioning of shapes is carried out on segments of images extracted from the obstacle mask, the extracted segments of images corresponding to the target zones, the extracted segments of images having preferentially undergone a rotation before the positioning of shapes;
the contour detection step is carried out by applying a Canny filter on the target image;
the method comprises a step of determining characteristics relating to the solar production of the determined arrangement of photovoltaic panels;
the arrangement of photovoltaic panels is determined so as to satisfy at least one other positioning requirement selected from the group consisting of:
   a. a requirement that each photovoltaic panel is positioned on a segment of a target zone corresponding to an irradiance greater than a predetermined irradiance over a given period of time.
   b. a requirement stipulating that each photovoltaic panel is positioned on a segment of a target zone shaded by possible obstacles over at most a predetermined percentage of the surface thereof over a given period of time.
   c. a requirement that each photovoltaic panel is positioned on a target zone such that same is at a distance greater than a predetermined minimum distance from possible obstacles and/or contours of the target zone;
the target zone(s) of the image are surfaces of human constructions, such as roofs;
the image is a two-dimensional image, e.g. an aerial image or a satellite image.

The present description further relates to a computer program product comprising program instructions stored on a computer-readable storage medium, for the execution of a method as described above when the computer program is executed on a computer.

The present description further relates to a readable information medium on which is stored a computer program product such as described hereinabove.

### BRIEF DESCRIPTION OF THE DRAWINGS

Other features and advantages of the invention will appear upon reading hereinafter the description of the embodiments of the invention, given only as an example, and making reference to the following drawings:

FIG. 1, a schematic view of an example of a computer used for the implementation of a method for determining an arrangement of photovoltaic panels on zones of a territory,

FIG. 2, a flowchart of an example of implementation of a method for determining an arrangement of photovoltaic panels on zones of a territory, and

FIG. 3 is a schematic representation showing examples of images obtained during the different steps of the method shown in FIG. 2.

### DETAILED DESCRIPTION

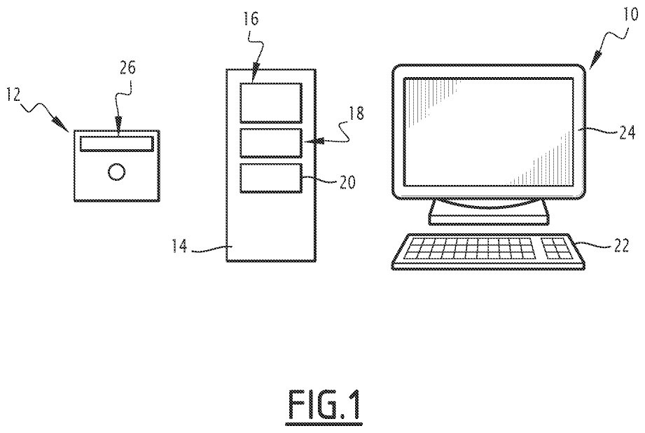

A calculator 10 and a computer program product 12 are shown in FIG. 1.

The calculator 10 is preferentially a computer.

More generally, the calculator 10 is an electronic calculator suitable for manipulating and/or transforming data represented as electronic or physical quantities in registers of the calculator 10 and/or memories into other similar data corresponding to physical data in memories, registers or other types of display, transmission or storage.

The calculator 10 interacts with the computer program product 12.

As shown in FIG. 1, the calculator 10 includes a processor 14 comprising a data processing unit 16, memories 18 and a data storage medium 20. In the example illustrated in FIG. 1, the calculator 10 comprises a keyboard 22 and a display unit 24.

The computer program product 12 includes a storage medium 26.

The storage medium 26 is a medium readable by the calculator 10, usually by the data processing unit 16. The readable storage medium 26 is a medium suitable for storing electronic instructions and apt to be coupled to a bus of a computer system.

As an example, the storage medium 26 is a diskette or a floppy disk, an optical disk, a CD-ROM, a magneto-optical disk, a ROM, a RAM, an EPROM, an EEPROM, a magnetic card or an optical card.

The computer program 12 containing program instructions is stored on the storage medium 26.

The computer program 12 can be loaded into the data processing unit 16 and is suitable for leading to the implementation of a method for determining an arrangement A of photovoltaic panels on the zones of a territory when the computer program 12 is implemented on the processing unit 16 of the calculator 10.

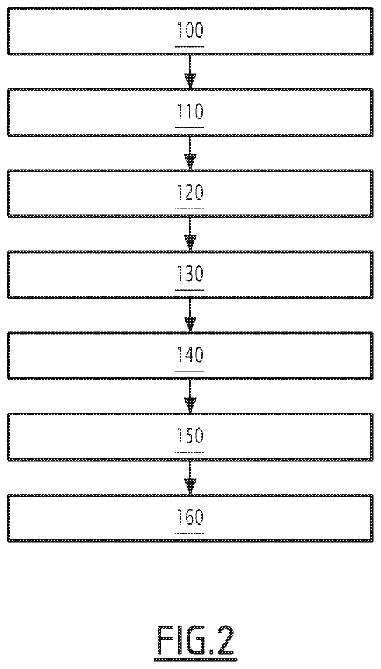

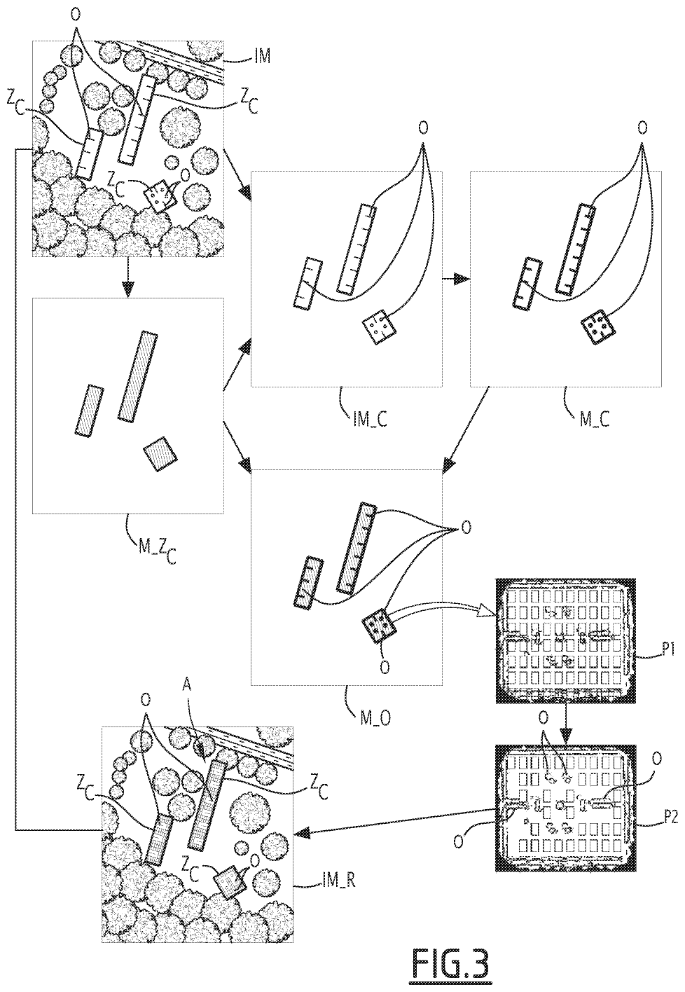

The operation of the calculator 10 will now be described with reference to FIG. 2 which schematically illustrates an example of the implementation for determining an arrangement A of photovoltaic panels on the zones of a territory, and to FIG. 3 illustrating certain steps of the method.

The determination method aims to determine an arrangement A of photovoltaic panels on zones of a territory, called target zones. The term “arrangement” means a number of photovoltaic panels, and an arrangement of said photovoltaic panels on target zones, namely a position and an orientation for each panel.

Each target zone Z_{C} typically has dimensions and a shape making possible the installation of one or a plurality of photovoltaic panels on the zone.

Each target zone Z_{C} is a zone of an open-air territory, i.e. receiving direct solar radiation.

For example, a target zone Z_{C} is a surface of a human construction. A target zone is thus a zone artificially created by man, also called anthropized zone. For example, a target zone Z_{C} is a roof, a terrace or a parking lot.

The target zones are likely to comprise obstacles O on the surface (surface receiving direct solar radiation) thereof. The term “obstacle” means an element present on the surface of the target zone Z_{C} and incompatible with the arrangement of a photovoltaic panel on such element. The obstacles O are e.g. chimneys, windows (velux), air conditioning systems or vegetation (trees, plants).

The determination method comprises a step 100 of reception of a bird's eye view image IM of a territory comprising at least one target zone Z_{C}. The step 100 is implemented by the calculator 10 in interaction with the computer program product 12, i.e. is implemented by computer.

The term “bird's eye view” means that the image IM was taken from a high point of view making it possible e.g. to image the roofs of buildings.

For example, the image IM was acquired by a satellite system. In a variant, the image IM was acquired by an acquisition system (camera) mounted on an aircraft.

The image IM is typically a geo-referenced image, i.e. each pixel of the image IM is associated with a latitude and a longitude.

Preferentially, the image IM is a two-dimensional image. Advantageously, the image IM is a color image.

FIG. 3 illustrates an example of an image IM of a territory comprising three target zones Z_{C}. Each target zone Z_{C} comprises obstacles O which will be identified hereinafter in the method.

The determination method comprises a step 110 of detection of each target zone Z_{C} on the image IM by segmenting the image IM so as to obtain a mask of the target zones Z_{C} of the image IM, called the zone mask M_Z_{C}. The step 110 is implemented by the calculator 10 in interaction with the computer program product 12, i.e. is implemented by computer. The segmentation is e.g. carried out via an edge detection algorithm.

The detected target zones Z_{C} are e.g. of the same nature (example: only roofs). In a variant, the target zones Z_{C} can be of different natures (e.g. roofs and terraces).

FIG. 3 shows an example of a zone mask M_Z_{C} obtained from an image IM.

The determination method comprises a step 120 of applying the zone mask M_Z_{C} to the image IM in order to obtain an image, referred to as the target image IM_C, on which only the target zone(s) Z_{C} of the image IM are represented. The step 120 is implemented by the calculator 10 in interaction with the computer program product 12, i.e. is implemented by computer.

The target image IM_C thereby corresponds e.g. to the image IM with application of a continuous background (e.g. black) on the segments of the image IM different from the target zones Z_{C}. The information and details of the target zones Z_{C} are thus kept on the target image IM_C.

FIG. 3 shows an example of a target image IM_C obtained from an image IM and a zone mask M_Z_{C}.

The determination method comprises a step 130 of detection of contours on the target image IM_C in order to obtain a contour mask M_C. The step 130 is implemented by the calculator 10 in interaction with the computer program product 12, i.e. is implemented by computer.

The detected contours materialize obstacles O on the target zone(s) Z_{C}. The obstacles O are in fact discontinuities on the surface of a target zone Z_{C}.

The contour detection step is e.g. carried out by applying a Canny filter to the target image IM_C.

In a variant, the filter applied is another contour detection filter such as e.g., a Prewitt or a Sobel filter.

FIG. 3 shows an example of a contour mask M_C obtained from a target image IM_C.

The determination method comprises a step 140 of identifying obstacles O on each target zone Z_{C} of the image IM by combining the zone mask M_Z_{C} and the contour mask M_C so as to obtain a mask of the obstacles O present on the target zone(s) Z_{C} of the image IM, called obstacle mask M_O. The step 140 is implemented by the calculator 10 in interaction with the computer program product 12, i.e. is implemented by computer.

The obstacle mask M_O thereby corresponds to the zone mask M_Z_{C} having superimposed on the target zones Z_{C}, detected contours materializing obstacles O (i.e. the contour mask M_C).

FIG. 3 illustrates an example of an obstacle mask M_O obtained from a zone mask M_Z_{C} and from a contour mask M_C.

The determination method comprises a step 150 of determination of an arrangement A of photovoltaic panels on each target zone Z_{C} of the image IM depending on the obstacle mask M_O so as to satisfy at least one positioning requirement. The step 150 is implemented by the calculator 10 in interaction with the computer program product 12, i.e. is implemented by computer.

At least one positioning requirement stipulates that each photovoltaic panel covers a segment of a target zone Z_{C} free of obstacles O.

In an example of implementation, the determination step 150 preferentially comprises the extraction of segments of images from the obstacle mask M_O. The extracted segments of images correspond to the target zones Z_{C}. Each segment of image has e.g. a predefined geometric shape, such as a rectanglular shape. The dimensions of each segment of image are chosen, e.g., so that the segment of image frames a target zone Z_{C}. For this purpose, the contour mask M_C is e.g. used for obtaining the contours of the target zone Z_{C} considered.

The determination step comprises the positioning of representative shapes of photovoltaic panels on the segment of images extracted from the obstacle mask M_O. The representative shapes are e.g. rectangles.

The positioning is e.g. carried out in such a way that the shapes have the same orientation and are at a predetermined distance from the other shapes. In a variant, at least one representative shape has an orientation different from the other shapes.

Preferentially, the positioning is performed on extracted segments of images having the same orientation. To this end, the segment of images have optionally been rotated before the positioning of shapes. When the segments of images are rectangles framing target zones Z_{C}, the segments of images are rotated e.g. so that the rectangles are vertical. The above facilitates the arrangement of representative rectangles of photovoltaic panels on the segments of images.

FIG. 3 illustrates an example of a rotated segment of images P1 on which rectangles representing photovoltaic panels have been superimposed.

In such example of embodiment, the shapes at least partially superimposed on an obstacle O are removed. In the example shown in FIG. 3, the segment of images obtained following the removal, is called P2.

The determined arrangement A of photovoltaic panels corresponds to the remaining shapes. More particularly, the position and the orientation of each shape corresponds to the position and the orientation of a photovoltaic panel.

Preferentially, at the end of the determination step, a resulting image IM_R is obtained corresponding to the image IM of the territory with the image IM of the determined arrangement A of photovoltaic panels superimposed on the target zone(s) Z_{C}. The resulting image IM_R is shown in FIG. 3.

The resulting image IM_R is e.g. obtained from the segment of images on which the representative shapes of photovoltaic panels are shown, and after a possible inverse rotation of the segments of images (when a rotation has been applied to the segments of images).

In another example of implementation, the representative shapes are directly superimposed on the obstacle mask M_O, without extracting segments of images.

As an optional addition, the arrangement A of photovoltaic panels is determined so as to satisfy at least one other positioning requirement selected from the group consisting of:
a requirement stipulating that each photovoltaic panel is positioned on a segment of a target zone Z_{C} corresponding to an irradiance greater than a predetermined irradiance over a given period of time. In such case e.g., an irradiance map corresponding to the investigated territory is provided. Irradiance, expressed in watts per square meter (W/m²), is the incident radiant flux (power) received by a surface per unit of surface area. The irradiance is e.g. determined by means of an irradiance mapping of the territory under consideration.
a requirement stipulating that each photovoltaic panel is positioned on a segment of a target zone Z_{C} shaded by possible obstacles O over at most a predetermined percentage of the surface thereof over a given period of time. In such case, information relating to the parts of the target zone Z_{C} shaded over time is e.g. provided.
a requirement stipulating that each photovoltaic panel is positioned on a target zone Z_{C} so as to be at a distance greater than a predetermined minimum distance from any obstacles and/or contours of the target zone Z_{C}. Such requirement makes it possible e.g. to comply with health and safety rules (HSE rules). For example, in the case of roofs, a minimum distance of each photovoltaic panel is given with respect to the edge of the roof, or with respect to obstacles on the roof, such as chimneys or windows.

Optionally, the determination method comprises a step 160 of determination of characteristics relating to the solar production of the determined arrangement A of photovoltaic panels. Such characteristics are, e.g., the irradiance of arrangement A, the solar potential or the efficiency of the arrangement A. Solar potential is the solar power received over a zone, in kilowatts per hour per year (kW/h/year). Efficiency is the ratio between the energy produced and the theoretical power of a plant.

Optionally, the method comprises a step of designing an arrangement A of photovoltaic panels corresponding to the panels of the determined arrangement A, followed, if appropriate, by the actual positioning of the photovoltaic panels on the target zones Z_{C} of the studied territory.

Thus, the present method is used for a more precise determination of the possibilities of installing photovoltaic panels on zones of a territory. More particularly, such a method makes it possible to take into consideration, obstacles incompatible with the effective installation of photovoltaic panels on the zones considered. The resulting panel arrangement is thus more realistic.

The accuracy of estimates of solar production for a future installation is thereby improved.

Furthermore, the present method is easy to implement. A person skilled in the art will understand that the embodiments and variants described above can be combined so as to form new embodiments provided that same are technically compatible.

1. A method for determining an arrangement of photovoltaic panels on zones of a territory, called target zones, the method being implemented by computer and comprising the following steps:
a. receiving of a bird's eye view image of a territory comprising at least one target zone,
b. detecting of each target zone on the image by segmenting the image so as to obtain a mask of the target zones of the image, called zone mask,
c. applying the zone mask on the image so as to obtain an image, called target image, on which only the target zone(s) of the image are represented,
d. detecting contours on the target image so as to obtain a contour mask, the detected contours representing obstacles on the target zone(s),
e. detecting obstacles on each target zone of the image by combining the zone mask and the contour mask so as to obtain a mask of the obstacles present on the target zone(s) of the image, called obstacle mask, and
f. determining an arrangement of photovoltaic panels on each target zone of the image based on the obstacle mask so as to satisfy at least one positioning requirement, the at least one positioning requirement stipulating that each photovoltaic panel covers a segment of a target zone free of obstacles.

2. Currently Amended) The method according to claim 1, wherein the method comprises, at the end of the determination step, obtaining a resulting image corresponding to the image of the territory with the image of the determined array of photovoltaic panels superimposed on the target zone(s).

3. The method according to claim 1, wherein the determination step comprises the positioning of representative shapes of photovoltaic panels on the surface of each target zone of the obstacle mask, followed by the removal of shapes at least partially superimposed on an obstacle, the determined arrangement of photovoltaic panels corresponding to the remaining shapes.

4. The method according to claim 3, wherein positioning of shapes is carried out on segments of images extracted from the obstacle mask, the extracted segments of images corresponding to the target zones.

5. The method according to claim 1, wherein the step of detection of contours is performed by applying a Canny filter to the target image.

6. The method according to claim 1, wherein the method comprises a step of determination of characteristics relating to the solar production of the determined array of photovoltaic panels.

7. The method according to claim 1, wherein the arrangement of photovoltaic panels is determined so as to satisfy at least one other positioning requirement selected from the group consisting of:
a. requiring each photovoltaic panel is positioned on a segment of a target zone corresponding to an irradiance greater than a predetermined irradiance over a given period of time,
b. stipulating that each photovoltaic panel is positioned on a segment of a target zone shaded by possible obstacles over at most a predetermined percentage of the surface thereof over a given period of time, and
c. requiring that each photovoltaic panel is positioned on a target zone such that same is at a distance greater than a predetermined minimum distance from possible obstacles and/or contours of the target.

8. The method according to claim 1, wherein the target zone(s) of the image are surfaces of human constructions, such as reefs.

9. The method according to claim 1, wherein the image is a two-dimensional image.

10. (canceled)

11. The method according to claim 3, wherein the extracted segments of images have undergone a rotation before the positioning of shapes.

12. The method according to claim 9, wherein the image is an aerial or a satellite image.

13. A readable information medium on which a computer program product according to claim 1 is stored.
